(19) United States
(12) Patent Application Publication
(10) Pub. No.: US 2009/0297842 A1
(43) Pub. Date: Dec. 3, 2009

(54) Oil-resistant sheet material

(76) Inventor: Kousuke Akiyama, Shizuoka (JP)

Correspondence Address: WENDEROTH, LIND & PONACK, L.L.P., 1030 15th Street, N.W.,, Suite 400 East, Washington, DC, 20005-1503, US

(21) Appl. No.: 11/919,053

(22) PCT Filed: Feb. 9, 2006
(86) PCT No.: PCT/JP2006/302237

§ 371 Date: Oct. 23, 2007

(30) Foreign Application Priority Data
Apr. 27, 2005 (JP) 2005-129136

(51) Int. Cl. B32B 5/00

(52) U.S. Cl. 428/341

(57) ABSTRACT

An oil-resistant sheet material is provided which has low resistance to air permeability and excellent oil resistance, and particularly can be suitably used as a packaging material for food containing edible oil. The oil-resistant sheet material includes at least one coating layer that contains starch and alkyl ketene dimer and/or alkenylsuccinic anhydride on at least one side of a substrate in a solid content of 1.5 to 20 g/cm². When the coating layer further contains a crosslinking agent, the oil resistance is improved.

### TECHNICAL FIELD

The present invention relates to a sheet material excellent in oil resistance and grease resistance. More specifically, the present invention relates to a sheet material that can be suitably used as a packaging material for food containing edible oil, such as breaded fried food and the like.

### BACKGROUND ART

Conventionally, in order to impart oil resistance to sheet materials such as paper, an approach has been taken to make the critical surface tension of a treated surface smaller than the surface tension of an oily substance. Chemicals with such function are called oil-resistant agents, and oil-resistant sheet materials treated with a fluorine containing oil-resistant agent have been mainly used.

For example, as Patent Document 1 presents a fluorine containing oil-resistant agent as a novel oil-resistant agent, those in which a fluorine containing compound such as acrylate or phosphoric ester of perfluorocarbon is used have been mainly used as oil-resistant agents for oil-resistant sheet materials because they are inexpensive and effective.

In the case of an oil-resistant sheet material using a fluorine containing oil-resistant agent, no coating is needed to be formed on the surface of the oil-resistant sheet material because the oil-resistant agent itself has excellent oil repellency and further stronger water repellency, and consequently the resistance to air permeability of the oil-resistant sheet material can be made low.

Recently, however, it has been revealed that when fried food is wrapped with such an oil-resistant sheet material using an oil-resistant agent of a fluorine containing compound and heated up in an electronic oven or the like at a high temperature of 100° C. or higher, harmful gas (fluoroalcohol gas, hydrogen fluoride gas, etc.) that can be accumulated in the human body is generated, and thus use of the fluorine containing oil-resistant agent has posed a serious problem. It has also been pointed out that even without heating in an electronic oven or the like, similar gas may be generated when such paper is used for packaging a food material having a temperature of 100° C. or higher.

In addition, fluorine containing organic compounds have extremely poor biodegradability and there is a global concern for pollution due to these substances. From a fear of such danger to human health and impact on the global environment as described above, the use of fluorine containing compounds has posed serious social problems.

Patent Document 2 proposes, as an invention related to an oil-resistant sheet material using no fluorine containing compound, a container made of an oil-resistant paper prepared by forming on the surface of the paper a barrier layer containing crosslinked polyvinyl alcohol and/or starch and a water resistant additive as main components and by applying to the barrier layer a silicone resin and an adhesive for heat sealing. However, this oil-resistant paper container does not always have satisfactory oil resistance, and further involves a problem such that the production cost of the container is high because silicone resin is expensive.

Patent Document 3, Patent Document 4 and Patent Document 5 propose oil-resistant paper using acrylic emulsion as an oil-resistant agent. However, these kinds of oil-resistant paper proposed in these Documents require a thick acrylic resin coating for satisfying desired oil resistance, resulting in an extremely high resistance to air permeability so as to impair the properties as a food packaging material. When a food packaging material has a high resistance to air permeability and food is heated or kept warm while being wrapped with the packaging material, the inside of the package is filled with vapor generated from food, and food is moistened with condensed dew, and texture and taste of the food are remarkably degraded as the case may be. In addition, when the food is reheated in an electronic oven or the like while being wrapped with the packaging material, rapidly generated vapor cannot be discharged to the outside and the package may be broken. Moreover, in order to form a coating having sufficient oil resistance, a large coating amount is needed, and consequently a problem of increased costs of packaging materials is caused.

When food is heated in an electronic oven or the like while being wrapped with a packaging material, the easiness in discharging of the vapor generated therein to the outside may be represented by the vapor permeability as well as the resistance to air permeability. As a method for measuring the vapor permeability, there is a method referred to as “the moisture permeability measurement method for moisture-proof packaging material” specified in JIS Z-0208 (1976), wherein the moisture permeability is defined as “the amount of the vapor passing through a unit area of a film material in a specified time.” However, this measurement method takes very long time, and is not suitable as a method expected to be compatible even with the cases involving such problems at the time of actually being used as food packaging materials that vapor is condensed as dew in the package, and the rapidly generated vapor cannot be discharged to the outside and the package is broken while food is heated in an electronic oven. Accordingly, as an evaluation test of the moisture permeability of such food packaging material as the present invention, it is preferable to examine the dew condensation conditions in a package and the package break conditions as observed by actually placing and heating food or a substitute therefor in the package.

On the other hand, in order to ensure high oil resistance, lamination of film on a sheet material has been generally practiced. However, when a film is laminated, even if oil resistance can be ensured, the resistance to air permeability becomes extremely high, and the resulting food packaging material is defective as described above.

To prevent the resistance to air permeability from becoming extremely high, Patent Document 6 proposes an air-permeable oil-resistant sheet material including a substrate such as a sheet of paper having pores and a thermoplastic film having pores similar to those of the substrate and being laminated on at least one side of the substrate. It is also proposed to form a laminate of non-woven fabric and paper. However, there has been a problem that, even if the resistance to air permeability causes no problem, such sheet materials cannot fully prevent edible oil from bleeding to the outside, and excellent oil resistance, a point of vital importance, has not been achieved.

Patent Document 7 proposes an oil-resistant paper using hydrophobized starch. However, for the purpose of achieving sufficient oil resistance by using only hydrophobized starch, an enormous amount of hydrophobized starch is required to be applied, and this is impractical in terms of the cost. In addition, increase in resistance to air permeability due to the increased coating amount also causes a problem. Further, when oil-resistant paper using hydrophobized starch alone is used as a food packaging material, there has been a problem that the starch is dissolved due to vapor generated from the food and adheres to the food because the starch is easily soluble in water.

Patent Document 8 proposes oil-resistant paper prepared by making non-sized paper uniformly contain starch, polyvinyl alcohol and an acrylic oil-resistant agent. However, this oil-resistant paper is also insufficient in oil resistance as a food packaging material, and accordingly, in order to ensure sufficient oil resistance, a large amount of coating layer is needed to be formed, resulting in a problem that the resistance to air permeability is increased.

Patent Document 9 proposes oil-resistant paper having on a paper substrate two coating layers, namely, a lower layer that is a coating layer composed of a mixture of an elastomer such as rubber latex or a water-retaining/water-absorbing polymer and a gelatinizable starch and an upper layer that is a coating layer composed of a starch decreased in viscosity or a starch derivative. This oil-resistant paper ensures the oil resistance mainly on the basis of starch and elastomer or a water-retaining/water-absorbing polymer, and hence, in order to ensure sufficient oil resistance, resistance to air permeability is forced to be sacrificed; consequently, no oil-resistant sheet material excellent in oil resistance and low in resistance to air permeability has been able to be obtained. Additionally, in this oil-resistant treated paper, the starch is used for the purpose of forming a film, and the resistance to air permeability is out of the scope of consideration.

On the other hand, the use of alkyl ketene dimer as a surface sizing agent for papermaking has hitherto been practiced, wherein the hydrophobicity of alkyl ketene dimer is utilized to impart water repellency to paper. Patent Document 10 proposes a surface sizing agent prepared by combining an alkyl ketene dimer emulsion with a water-soluble polymer compound such as starch oxide wherein the alkyl ketene dimer emulsion is prepared by emulsifying alkyl ketene dimer in water with the aid of a cation group-containing polymer compound, and the emulsion thus obtained is made to include an water-soluble metal salt so as to regulate the zeta potential of the emulsion at a specific value. This surface sizing agent is basically different from the present invention that intends to impart oil resistance because the surface sizing agent imparts water repellency to paper. In other words, many of water repellency-imparting substances generally have a lipophilic group, and hence, even those skilled in the art can hardly think up such an idea that a water repellency-imparting alkyl ketene dimer is utilized to impart oil resistance; actually, application of alkyl ketene dimer alone to a paper substrate does not bring about any oil resistance at all.

Patent Document 11 proposes to add in a coating solution alkyl ketene dimer as a lubricant for a rod metering size press. Patent Document 12 proposes to use alkyl ketene dimer for the purpose of imparting water repellency to printing paper. However, these inventions utilize the lubricity and water repellency of alkyl ketene dimer; in other words, alkyl ketene dimer is not used for the purpose of blocking oil permeation. Thus, needless to say, it has never been studied to apply alkyl ketene dimer to an oil-resistant sheet material for the purpose of improving the oil resistance thereof.

On the other hand, alkenylsuccinic anhydride is generally used for papermaking as an internally added sizing agent to improve the Stockigt sizing degree of paper; however, alkenylsuccinic anhydride has hardly been added to a coating layer for the purpose of improving the oil resistance thereof.

Patent Document 13 proposes an oil-resistant sheet material prepared by using a sheet material mainly including a papermaking pulp wherein guar gum and a fatty acid are internally added. However, this oil-resistant sheet material does not always have a satisfactory oil resistance; thus, in order to obtain a sufficient oil resistance, an additional oil-resistant layer is needed to be formed on the surface thereof.

As described above, the conventional art has never been able to produce any oil-resistant sheet material that can simultaneously satisfy desired oil resistance, resistance to air permeability and productivity so as to be suitable as a food packaging material.

[Patent Document 1]: Japanese Patent Laid Open No. 12-026601

[Patent Document 2]: Japanese Patent Publication No. 6-2373

[Patent Document 3]: Japanese Patent Laid Open No. 9-3795

[Patent Document 4]: Japanese Patent Laid Open No. 9-111693

[Patent Document 5]: Japanese Patent Laid Open No. 2001-303475

[Patent Document 6]: Japanese Patent Laid Open No. 11-021800

[Patent Document 7]: Japanese Patent Laid Open No. 2002-69889

[Patent Document 8]: Japanese Patent Laid Open No. 2005-29943

[Patent Document 9]: Japanese Patent Laid Open No. 2005-29941

[Patent Document 10]: Japanese Patent Laid Open No. 2003-221795

[Patent Document 11]: Japanese Patent Laid Open No. 2004-300590

[Patent Document 12]: Japanese Patent Laid Open No. 2003-278096

[Patent Document 13]: Japanese Patent Laid Open No. 2005-60868

### DISCLOSURE OF THE INVENTION

An object of the present invention is to solve the problem of harmful effect on humans and environmental load caused by conventional oil-resistant sheet materials that uses fluorine containing oil-resistant agents and the problems related to the high resistance to air permeability and high cost of oil-resistant sheet materials that use oil-resistant agents containing no fluorine. More specifically, the object of the present invention is to provide an oil-resistant sheet material having low resistance to air permeability, and being harmless to humans and excellent in oil resistance and in productivity.

The invention of claim 1 of the present application is an oil-resistant sheet material characterized in that at least one coating layer containing starch, and alkyl ketene dimer and/or alkenylsuccinic anhydride is formed on at least one side of a substrate in a solid content of 1.5 to 20 g/m².

The invention of claim 2 of the present application is the oil-resistant sheet material according to claim 1, wherein the coating layer further contains a crosslinking agent.

The invention of claim 3 of the present application is the oil-resistant sheet material according to claim 2, wherein the crosslinking agent is an epichlorohydrin crosslinking agent.

The invention of claim 4 of the present application is the oil-resistant sheet material according to any one of claims 1 to 3, wherein the starch is a hydrophobized starch.

The invention of claim 5 of the present application is the oil-resistant sheet material according to any one of claims 1 to 4, wherein the resistance to air permeability specified in JIS P-8117 is 10000 seconds or less.

According to the present invention, an oil-resistant sheet material having low resistance to air permeability, and being harmless to humans and excellent in oil resistance and in productivity can be obtained. The oil-resistant sheet material of the present invention can be particularly suitably used as a packaging material for food containing edible oil.

### BEST MODE FOR CARRYING OUT THE INVENTION

It is essential that a coating layer in the oil-resistant sheet material of the present invention contains starch, and alkyl ketene dimer and/or alkenylsuccinic anhydride. The present inventor has verified that by including starch, and alkyl ketene dimer and/or alkenylsuccinic anhydride in the coating layer, the oil resistance is drastically improved to such an extent that cannot be expected when starch is used alone. The oil-resistant sheet material as referred to in the present invention means every sheet material having capability of blocking oil permeation. In general, the oil resistance, namely, the capability of blocking oil permeation is evaluated by measuring the permeation time of oils such as castor oil. Here, the oil permeation time is measured as the time in which a drop of oil placed on the surface of a sample in an environment of 23° C. and 50% R.H. perfectly permeates the sample to reach the reverse side thereof. Perfect permeation means the condition that the surface area with the drop of oil placed thereon is transferred to the reverse side without any change of the area, and such condition is visually checked. The oil-resistant sheet material as referred to in the present invention means such paper that has a castor oil permeation time of 0.5 hour or more.

Examples of the starch usable in the present invention include, in addition to common starch, etherified starch, esterified starch, crosslinked starch, roasted starch, hydrophobized starch and enzyme-modified starch such as grafted starch, hydroxypropyl starch, carboxymethyl starch, cationic starch, starch acetate, starch phosphate, distarch phosphate, starch octenylsuccinate, glycerol distarch, white dextrin, yellow dextrin, British gum, maltodextrin, starch oxide, acid-treated starch and alpha starch. Further, granular starch prepared by granulation, porous oil-absorbing starch and the like can be preferably used. In particular, preferably use of hydrophobized starch increases the oil resistance. The reason for the increase of the oil resistance due to the use of hydrophobized starch is not clear; it is assumed that some reaction of alkyl ketene dimer and/or alkenylsuccinic anhydride with hydrophobized starch improves the oil resistance.

Examples of the hydrophobized starch usable in the present invention include any hydrophobized starch as long as it has been subjected to hydrophobization. Examples of the methods for hydrophobizing starch include: a method in which starch is brought into close contact with an aqueous solution of organosilane in the presence of an alkali aluminate or an alkali hydroxide; a method in which starch is converted into a derivative with the aid of silicone or alkenyl; a method in which in an aqueous system, starch is reacted with an organic acid anhydride such as octenylsuccinic anhydride or dodecenylsuccinic anhydride; a method in which starch is copolymerized with a hydrophobic monomer such as acrylonitrile or a hydrophobic unsaturated monomer; a method in which a hydrophobic group containing a hydrocarbon group is imparted to starch through etherification or esterification; and a method in which starch is converted into starch alkyl-succinate. However, the method for hydrophobizing starch is not limited to these methods. In particular, a hydrophobized starch, prepared by reacting starch with an organic acid anhydride in an aqueous system to process the starch so as to have a hydrocarbon group having 6 to 22 carbon atoms, attains a more excellent oil resistance, and hence can be preferably used.

Examples of the alkyl ketene dimer usable in the present invention include alkyl ketene dimers prepared by any method and having any form. Examples of the method for preparing alkyl ketene dimer may include a general method in which stearic acid or palmitic acid is converted into a fatty acid chloride by the phosgene method or the phosphorus trichloride method, and the fatty acid chloride is treated with triethylamine to yield an alkyl ketene dimer; however, the method for preparing an alkyl ketene dimer is not limited to this method. Additionally, examples of a general form of alkyl ketene dimer include an emulsified form in which an alkyl ketene dimer is emulsified by applying high shear force in the concomitant presence of an anionic polymer such as lignosulfonic acid, aluminum sulfate or cationic starch; however, the form of alkyl ketene dimer is not limited to this form. Additionally, usable are those alkyl ketene dimers treated in such a way that a double bond is introduced by using oleic acid, isostearic acid or the like as a starting material so as to maintain a liquid state at room temperature. Alkyl ketene dimers are commercially available, for example, from Seiko PMC Chemical Corp. under the trade names of “Sizing Agent AD1602,” “Sizing Agent AD1604” and “Surface Sizing Agent SE2160”; from Arakawa Chemical Industries, Ltd. under the trade names of “Size Pine K-903,” “Size Pine K-910,” “Size Pine K-287,” “Size Pine K-920”; from Harima Chemicals, Inc. under the trade name of “Harsize L-50”; and from BASF Japan, Ltd. under the trade names of “Basoplast 860 Dap.” Needless to say, the alkyl ketene dimers used in the present invention are not limited to these commercial products.

Examples of the alkenylsuccinic anhydride used in the present invention include alkenylsuccinic anhydrides prepared by any method and having any form. Alkenylsuccinic anhydride is generally used as a sizing agent for papermaking. Alkenylsuccinic anhydride is generally synthesized as follows: an external olefin having 16 to 18 carbon atoms is isomerized in the presence of a catalyst to prepare an internal olefin mixture, and the mixture is subjected to an ene-addition reaction in which the mixture is heat-treated with maleic anhydride to introduce a succinic anhydride group into an alkenyl chain, thereby yielding the above-mentioned alkenylsuccinic anhydride. In papermaking process, when an alkenylsuccinic anhydride is used, generally the alkenylsuccinic anhydride is emulsified before use with cationic starch or the like and then added; in the present invention, alkenylsuccinic anhydride may be used as emulsified or used in other forms. Alkenylsuccinic anhydride is commercially available, for example, from Arakawa Chemical Industries, Ltd. under the trade names of “Size Pine SA-862” and “Size Pine SA-864”; from Seiko PMC Chemical Corp. under the trade names of “Sizing Agent AS1532” and “Sizing Agent AS1524”; and from Nippon NSC Ltd. under the trade name of “FIBRAN 81.” Needless to say, the alkenylsuccinic anhydride used in the present invention is not limited to these commercial products.

The alkyl ketene dimer and/or alkenylsuccinic anhydride used in the present invention has a melting point of preferably 20° C. or higher, more preferably 40° C. or higher. When the coating layer containing alkyl ketene dimer and/or alkenylsuccinic anhydride having a melting point of lower than 20° C. is applied to the substrate to form a sheet material, the sheet material becomes oily and difficult to handle. When the sheet material containing alkyl ketene dimer and/or alkenylsuccinic anhydride having a melting point of lower than 40° C. is used as a food packaging material, there is a possibility that the alkyl ketene dimer and/or alkenylsuccinic anhydride is melted during heating food or during keeping food warm, and the oil resistance is thereby degraded as the case may be.

Alkyl ketene dimer and/or alkenylsuccinic anhydride is added to starch in a solid content of preferably 1 to 30% by weight, more preferably 3 to 15% by weight based on the total weight of the solid content of the starch. When the proportion is less than 1% by weight, no sufficient oil resistance is attained as the case may be, and when the proportion is less than 3% by weight, no sufficient oil resistance to a low-viscosity oil such as salad oil is attained as the case may be. When the proportion is more than 30% by weight, unpreferably the oil resistance is not improved in proportion to the amount added, to be disadvantageous in terms of the cost, and additionally, when the proportion of the alkyl ketene dimer and/or alkenylsuccinic anhydride is too large in relation to starch, the proportion of the starch in the coating layer is decreased, and consequently, the oil resistance of the sheet material is unpreferably decreased. In addition, when alkyl ketene dimer is used, the surface friction coefficient of the sheet material tends to be decreased; when more than 15% by weight of alkyl ketene dimer is added to the coating layer, the sheet material surface becomes. extremely slippery to be difficult to handle.

When the coating layer contains alkyl ketene dimer and/or alkenylsuccinic anhydride, the oil resistance is markedly improved. The reason for this improvement is not clear; it is assumed that the alkyl ketene dimer and/or alkenylsuccinic anhydride increases the capability of the coating layer to absorb the oil permeating the sheet so as to block the permeation of the oil in the sheet material. Additionally, because the coating layer containing only either alkyl ketene dimer or alkenylsuccinic anhydride cannot ensure the oil resistance, it is assumed that the oil resistance is improved owing to some action or reaction brought about by the combination of starch with alkyl ketene dimer and/or alkenylsuccinic anhydride.

The present inventor has found the following: when alkyl ketene dimer and/or alkenylsuccinic anhydride is mixed with starch to form a coating layer, the alkyl ketene dimer and/or alkenylsuccinic anhydride has an effect to prevent starch from forming coating and consequently has an effect to decrease the resistance to air permeability, in addition to the oil resistance improvement effect; thus, although the resistance to air permeability is decreased, the oil resistance is not decreased, and can even be improved. Such excellent features are extremely effective for packaging materials, required to maintain low resistance to air permeability and to have high oil resistance, such as food packaging materials to be used in an electronic oven and packaging materials for food material containing moisture.

When the coating layer contains alkyl ketene dimer and/or alkenylsuccinic anhydride, the alkyl ketene dimer and/or alkenylsuccinic anhydride serves as a release agent and can thereby attain an effect to prevent the dryer from being stained when the coating layer is formed by size-press coating. In other words, addition of alkyl ketene dimer and/or alkenylsuccinic anhydride to the coating layer improves the oil resistance of the obtained sheet material and at the same time brings about an effect to prevent the dryer from being stained, when the coating layer is formed by size-press coating, thus the productivity being able to be improved.

In the present invention, the configuration in which a coating layer containing starch and alkyl ketene dimer and/or alkenylsuccinic anhydride is formed may include a configuration in which a coating layer containing a mixture of starch and alkyl ketene dimer and/or alkenylsuccinic anhydride is formed, and a configuration in which a coating layer containing starch and a coating layer containing alkyl ketene dimer and/or alkenylsuccinic anhydride are formed separately. In other words, in the present invention, as long as the coating layer contains starch and alkyl ketene dimer and/or alkenylsuccinic anhydride, these components may be applied as a mixture, or may be applied as separate layers. Needless to say, the coating materials to be applied to form the coating layers may be added with other components commonly used as additives for coating materials.

The coating layer containing starch and alkyl ketene dimer and/or alkenylsuccinic anhydride is needed to be formed on at least one side of the substrate in a solid content of 1.5 to 20 g/m². When the solid content is less than 1.5 g/m², no sufficient oil resistance can be ensured. When the solid content is more than 20 g/m², the resistance to air permeability is increased, consequently the sheet material package thereby tends to be broken at the time of heat treating or the like, and additionally the moisture permeability and the hot water resistance are degraded, and further the oil resistance is not improved in proportion to the coating amount to be disadvantageous in terms of the cost. Such coating layer may be formed on both sides of the substrate according to need, and in that case, the coating amount is preferably regulated in such a way that the total coating amount of the coating layers on both sides is set to fall within the above-described coating amount range. For the purpose of imparting to the sheet material the oil resistance to a low-viscosity oil such as salad oil, it is effective to make the amount of the coating layer larger than 2.5 g/m².

In the present invention, by crosslinking starch through adding a crosslinking agent to the coating layer containing starch and alkyl ketene dimer and/or alkenylsuccinic anhydride, the oil resistance can be further improved. The reason for this improvement is not clear. However, because no oil resistance of the sheet material is attained by applying only a crosslinking agent to the substrate, it is assumed that some action, exerted by the crosslinking agent component to the alkyl ketene dimer and/or alkenylsuccinic anhydride and starch, improves the oil resistance of the sheet material.

The crosslinking agent used in the present invention is not particularly limited as long as it is capable of crosslinking starch. Examples of the usable crosslinking agent include glyoxal, dialdehyde, polyacrolein, N-methylolurea, N-methylolmelamine, activated vinyl compounds, various esters, diisocyanate and urethane crosslinking agents. In view of economic efficiency, reaction stability and effects on food and others, epichlorohydrin crosslinking agents such as epichlorohydrin resin are preferably used. Epichlorohydrin crosslinking agents are commercially available, for example, from Arakawa Chemical Industries, Ltd. under the trade name of “Arafix 100” and “Arafix 255”; from Showa Highpolymer Co., Ltd. under the trade names of “Polyfix 259” and “Polyfix 301”; from Sumitomo Chemical Co., Ltd. under the trade names of “SumirazeResin 650” and “SumirazeResin 6615”; from Seiko PMC Chemical Corp. under the trade names of “Wet Paper Strength Agent WS4002,” “Wet Paper Strength Agent WS40240,” “Wet Paper Strength Agent WS4024,” “Wet Paper Strength Agent WS4044” and “Wet Paper Strength Agent WS4010”; from Toho Chemical Industry Co., Ltd. under the trade names of “Sparamine 30,” “Sparamine AX-250F” and “Sparamine C-305”; and from Nicca Chemical Co., Ltd. under the trade name of “Totas 604T.” Needless to say, the epichlorohydrin crosslinking agents used in the present invention are not limited to these commercial products.

The crosslinking agent is added to starch in a solid content of preferably 1 to 30% by weight, more preferably 5 to 30% by weight based on the total weight of the solid contents of starch. Even when the proportion is more than 30% by weight, unpreferably no effect is attained in proportion to the amount added, to be disadvantageous in terms of the cost. Additionally, when the amount of the crosslinking agent added is too large, the proportion of starch based on the total coating amount is small, and unpreferably the oil resistance is thereby degraded. In particular, when the sheet material is used as a food packaging material or the like, no superfluous chemicals are to be added in view of the danger to human health. On the other hand, when the proportion is less than 1% by weight, no sufficient effect due to the added crosslinking agent is unpreferably attained as the case may be, and when the proportion is less than 5% by weight, no sufficient oil resistance against easily-penetrating oils, for example, is unpreferably attained as the case may be. By adding a crosslinking agent to starch, there is also obtained an effect to suppress the dissolution of starch due to water. For example, when the sheet material is used as a food packaging material, the above-mentioned effect preferably prevents such a problem that the starch is dissolved due to vapor generated from the food and adheres to the food.

As described above, when hydrophobized starch is used as starch, the oil resistance is improved as compared to other types of starch. Preferably, combination of hydrophobized starch and a crosslinking agent drastically improves the oil resistance. The reason for this improvement is not clear; it is assumed that the hydrophobic groups in the hydrophobized starch and the crosslinking agent cause some special reaction therebetween that is not expected to occur with other types of starch. Particularly, combination of hydrophobized starch and an epichlorohydrin crosslinking agent makes the above-mentioned effect remarkable.

For the purpose of further imparting particular properties such as heat sealing properties and releasing properties to the oil-resistant sheet material of the present invention, an additional layer may be formed according to required properties which are provided by a heat sealing agent, a release agent or the like.

In the present invention, conventional chemicals for papermaking may be added to the coating layer within the ranges that do not impair the properties of the oil-resistant sheet material. For example, a surface sizing agent, a dryer release agent, an antifoaming agent, a surface strength agent or an antistatic agent may be added as an additional component to the coating layer according to the intended applications of the oil-resistant sheet material.

In the present invention, the substrate on which the coating layer is formed is not particularly limited, but from the viewpoint of the resistance to air permeability, a sheet material including vegetable fiber as a main component is preferred. Examples of the vegetable fibers used for the substrate include: wood pulps such as softwood bleached kraft pulp (NBKP), hardwood bleached kraft pulp (LBKP), softwood bleached sulfite pulp (NBSP) and thermomechanical pulp (TMP); bast fibers obtained, for example, from paper mulberry, mitsumata (Edgeworthia papyrifera) and ganpi (Thymelaeaceae); and non-wood pulps obtained, for example, from straw, bamboo, kenaf and bagasse; these may be used each alone or in an appropriate combination according to need. Further, according to need, synthetic pulps, synthetic fibers, semi-synthetic fibers, inorganic fibers and the like may also be used in appropriate combinations.

When a papermaking pulp is used as vegetable fiber, the beating degree is preferably 100 to 500 ml in Canadian Standard Freeness. When the beating degree is lower than 100 ml, unpreferably the drainage on machine wire becomes poor, when manufacturing paper, to remarkably decrease the production efficiency, and the density of paper becomes excessively high so as to make the resistance to air permeability tend to be high. When the beating degree is 500 ml or more, unpreferably no sufficient oil resistance is obtained as the case may be.

As an auxiliary substance for papermaking, commonly used auxiliary substances for papermaking may be used. In particular, when guar gum, a fatty acid sizing agent, alkyl ketene dimer and/or alkenylsuccinic anhydride, a water resistant additive, aluminum sulfate or the like is used as an internal additive, the oil resistance of paper itself is improved, and when combined with the coating layer of the present invention, excellent oil resistance can be preferably achieved.

Examples of the method usable for forming the coating layer on the substrate in the present invention may include: various coaters such as a size press coater, a gate roll coater, a symsizer, a billblade coater, a rod-metering coater, a blade-metering coater, an air knife coater, a roll coater, a reverse roll coater, a bar coater, a rod coater, a blade coater, a curtain coater, a gravure coater, a die slot coater and a short dwell coater; a dipping machine; and various printing machines. However, the usable apparatuses are not limited to these examples.

As the above-mentioned method for forming the coating layer on the substrate, those methods in which the coating layer is formed by a coating apparatus installed in the papermaking process such as a size press coater, a gate roll coater or a symsizer are extremely advantageous in terms of the cost. The coating apparatus installed in the papermaking process, as referred to herein, means an apparatus in which the paper drying zone is divided into two or more zone sections between which coating is carried out. When the coating layer is formed by using a coating apparatus installed in the papermaking process, the coating amount is preferably 1.5 to 7 g/m². When the coating amount is more than 7 g/m², unpreferably the dryer is possibly stained at the time of drying. When the coating is carried out by using a coating apparatus installed in the papermaking process, the oil resistance is improved as compared to other coating methods. It is conceivably because the coating solution is more readily impregnated into paper by this method than by other methods.

In the present invention, the coating layer containing the predetermined components is formed on the substrate, and in addition, starch may be contained also in the substrate itself, and thus the oil resistance of the sheet material can be further improved. In this case, the content of the starch is preferably 1 to 15% by weight based on the total weight of the substrate. When the content is less than 1% by weight, no sufficient effect due to contained starch is attained as the case may be. Even when starch is contained in a content of more than 15% by weight, the oil resistance is not improved to be disadvantageous in terms of the cost. When a paper substrate is adopted, a papermaking raw material containing an excessively large amount of starch, which is a hydrophilic component, unpreferably degrades the drainage in papermaking process to significantly degrade the productivity. Additionally, when the substrate contains hydrophobized starch as starch to be contained therein, the oil resistance is preferably improved as compared to common starch. It is to be noted that a papermaking raw material may contain, in combination with starch, other auxiliary substances for papermaking, and oil resistance-improving chemicals such as guar gum, alkyl ketene dimer and alkenylsuccinic anhydride.

The oil-resistant sheet material of the present invention preferably has a resistance to air permeability of 10000 seconds or less. The resistance to air permeability as referred to herein means a measured value of the air permeance of a sheet of paper as specified in JIS P-8117. When the oil-resistant sheet material has a resistance to air permeability exceeding 10000 seconds and is used as a food packaging material, as described above, heating food or keeping food warm while being wrapped with the packaging material leads to such results that the inside of the package is filled with vapor generated from food, and the food is moistened with condensed dew, and texture and taste of the food are remarkably degraded as the case may be. In addition, when food is heated in an electronic oven or the like while being wrapped with the packaging material, there is a danger that rapidly generated vapor cannot be discharged to the outside and the package may be broken.

### EXAMPLES

### Example 1

As wood pulp, 50% by weight of hardwood bleached kraft pulp and 50% by weight of softwood bleached kraft pulp were used and beaten with a double disk refiner to prepare a raw material pulp slurry having a beating degree of 350 ml in Canadian Standard Freeness. To the raw material pulp slurry, an epichlorohydrin wet strength agent (trade name: Polyfix 259, manufactured by Showa Highpolymer Co., Ltd.) in a solid content concentration of 0.5% by weight based on the weight of the pulp, a rosin sizing agent (trade name: Sizing Agent AL1203, manufactured by Seiko PMC Chemical Corp.) in a solid content concentration of 0.5% by weight based on the weight of the pulp and aluminum sulfate in a proportion of 4% by weight based on the weight of the pulp were added to prepare a raw material slurry. The raw material slurry was subjected to papermaking to prepare a paper substrate so as to have a basis weight of 42 g/m², by means of a common method with a Fourdrinier paper machine.

Next, a coating solution was prepared by mixing starch oxide with alkyl ketene dimer (trade name: Sizing Agent AD1606, manufactured by Seiko PMC Chemical Corp.) added so as to have a solid content concentration of 5% by weight based on the weight of the starch oxide. An oil-resistant sheet material having a basis weight of 45 g/m² was prepared by manually applying the coating solution to both sides of the paper substrate prepared above in such a way that the total amount of the coating layers formed on both sides of the sheet with this coating solution was 3.0 g/m².

### Example 2

An oil-resistant sheet material having a basis weight of 45 g/m² was prepared in the same manner as in Example 1 except that acetic acid-esterified starch was used in place of starch oxide.

### Example 3

An oil-resistant sheet material having a basis weight of 45 g/m² was prepared in the same manner as in Example 1 except that a hydrophobized starch prepared by reacting an organic acid anhydride with starch was used in place of starch oxide.

### Example 4

An oil-resistant sheet material having a basis weight of 45 g/m² was prepared in the same manner as in Example 1 except that alkenylsuccinic anhydride (trade name: Size Pine SA-862, manufactured by Arakawa Chemical Industries, Ltd.) was used in place of alkyl ketene dimer.

### Example 5

An oil-resistant sheet material having a basis weight of 45 g/m² was prepared in the same manner as in Example 1 except that alkenylsuccinic anhydride was further added in an amount of 50% by weight based on the weight of the alkyl ketene dimer.

### Example 6

An oil-resistant sheet material having a basis weight of 45 g/m² was prepared in the same manner as in Example 1 except that polyamide-epichlorohydrin resin (trade name: Wet Paper Strength Agent WS4002, manufactured by Seiko PMC Chemical Corp.) was added as a crosslinking agent to the coating solution in a solid content concentration of 10% by weight based on the weight of the starch oxide.

### Example 7

An oil-resistant sheet material having a basis weight of 45 g/m² was prepared in the same manner as in Example 3 except that polyamide-epichlorohydrin resin was added as a crosslinking agent to the coating solution in a solid content concentration of 10% by weight based on the weight of the hydrophobized starch.

### Example 8

An oil-resistant sheet material having a basis weight of 45 g/m² was prepared in the same manner as in Example 4 except that polyamide-epichlorohydrin resin was added as a crosslinking agent to the coating solution in a solid content concentration of 10% by weight based on the weight of the starch oxide.

### Example 9

An oil-resistant sheet material having a basis weight of 45 g/m² was prepared in the same manner as in Example 5 except that polyamide-epichlorohydrin resin was added as a crosslinking agent to the coating solution in a solid content concentration of 10% by weight based on the weight of the starch oxide.

### Example 10

An oil-resistant sheet material having a basis weight of 44 g/m² was prepared in the same manner as in Example 7 except that total amount of the coating layers on both sides of the sheet was 2.0 g/m².

### Example 11

An oil-resistant sheet material having a basis weight of 45 g/m² was prepared as follows: an oil-resistant sheet material was prepared in the same manner as in Example 1 except that the amount of the coating layers on both sides was 2.5 g/m², and then on the surface of the oil-resistant sheet material thus prepared, coating layers containing only alkyl ketene dimer were further formed in such a way that the total amount of the additional coating layers on both sides was 0.5 g/m².

### Comparative Example 1

An oil-resistant sheet material having a basis weight of 45 g/m² was prepared by applying, to the paper substrate prepared in Example 1, a coating solution containing only starch oxide in such a way that the total amount of the coating layers on both sides was 3.0 g/m².

### Comparative Example 2

An oil-resistant sheet material having a basis weight of 45 g/m² was prepared in the same manner as in Comparative Example 1 except that, to the coating solution, polyamide-epichlorohydrin resin was added as a crosslinking agent in a solid content concentration of 10% by weight based on the weight of the starch oxide.

### Comparative Example 3

An oil-resistant sheet material having a basis weight of 67 g/m² was prepared in the same manner as in Example 1 except that the coating solution was applied in such a way that the total amount of the coating layers on both sides was 25 g/m².

### Comparative Example 4

An oil-resistant sheet material having a basis weight of 43 g/m² was prepared in the same manner as in Example 1 except that the coating solution was applied in such a way that the total amount of the coating layers on both sides was 1.0 g/m².

### Comparative Example 5

An oil-resistant sheet material having a basis weight of 45 g/m² was prepared by laminating a 4-μm thick polyethylene film on one side of the paper substrate prepared in Example 1.

### Comparative Example 6

An oil-resistant sheet material having a basis weight of 45 g/m² was prepared in the same manner as in Comparative Example 1 except that a hydrophobized starch prepared by reacting an organic acid anhydride with starch was used in place of starch oxide.

### Comparative Example 7

An oil-resistant sheet material having a basis weight of 45 g/m² was prepared by applying a coating solution containing only alkyl ketene dimer to the paper substrate prepared in Example 1 in such a way that the total amount of the coating layers on both sides was 3.0 g/m².

Table 1 shows the evaluation results of the properties of the oil-resistant sheet materials prepared in above Examples 1 to 12 and Comparative Examples 1 to 7. The oil resistance, moisture permeability, hot water resistance, breakage of package and resistance to air permeability were evaluated according to the following individual methods. The hot water resistance may not be required in some applications of oil-resistant sheet materials and was accordingly evaluated as reference. Thus, those oil-resistant sheet materials in each of which all of the oil resistance, moisture permeability, breakage of package and resistance to air permeability were evaluated to be at acceptable levels or above were graded as a “pass.”

### <Evaluation Test of Oil Resistance>

The oil resistance was evaluated as follows: a 0.5-ml drop of castor oil was placed on the surface of an oil-resistant sheet material, a load of 5 g/cm² was applied to the surface area with the drop of castor oil placed thereon (a metal plate was used for application of load), and the reverse side of the surface area with the drop of castor oil placed thereon was visually observed at predetermined elapsed times to evaluate the permeation behavior of the placed drop of cater oil on the reverse side. The maximum measurement time was set at 24 hours and the permeation degree of the placed drop of castor oil to the reverse side was visually determined. The evaluation criteria of permeation degree of castor oil were as follows. “Δ” and higher marks were graded as a “pass.” It is to be noted that the “permeation of castor oil” as described in the following evaluation criteria means a condition that a small gloss oil spot that was barely identifiable was observed on the reverse side by visual observation.

[symbol] No permeation of castor oil was observed on the reverse side of the surface area with a drop of castor oil placed thereon after 24 hours from placing of the drop of castor oil.

◯: The permeation of castor oil was observed on the reverse side of the surface area with a drop of castor oil placed thereon between 12 and 24 hours after placing of the drop of castor oil.

Δ: Permeation of castor oil was observed on the reverse side of the surface area with a drop of castor oil placed thereon between 6 and 12 hours after placing of the drop of castor oil.

×: Permeation of castor oil was observed on the reverse side of the surface area with a drop of castor oil placed thereon within 6 hours after placing of the drop of castor oil.

### <Evaluation Test of Moisture Permeability>

In a beaker, 100 ml of boiling water was placed, and a bag-shaped sample of an oil-resistant sheet material was put over the top of the beaker. The beaker was left for 1 hour and dew condensation to the inside of the bag was visually observed. The evaluation criteria of dew condensation were as follows. “Δ” and higher marks were graded as a “pass”. It is to be noted that the dew condensation means the generation of droplets of water on the inside surface of the bag, and a drop of water means an aggregation of such two or more droplets of water to drop or to be large enough to drop.

[symbol] No dew condensation was found inside the bag after leaving for 1 hour.

◯: Some degree of dew condensation was found inside the bag after leaving for 1 hour.

Δ: Dew condensation was found all over the inside of the bag after leaving for 1 hour, but no drop of water was formed.

×: Dew condensation was found inside the bag after leaving for 1 hour and drops of water were formed.

### <Evaluation Test of Hot Water Resistance>

The hot water resistance was evaluated by a method in which a sample of an oil-resistant sheet material was cut to a square piece of 5-cm sides and extraction was performed in 100 ml of hot water for 10 minutes, thereafter the sample was taken out, and then the extract solution was evaporated to measure the evaporation residue. The test result was evaluated as follows: a total extract amount of 2 mg/25 cm² or less was graded as “◯” and a total extract amount of more than this value was graded as “×”.

### <Evaluation Test of Breakage of Package>

A bag of an oil-resistant sheet material having a size of 8 cm×14 cm and provided with an opening for putting a sponge on one end thereof was prepared. A sponge having a size of 5 cm×7 cm×4 cm impregnated with 20 ml of water was put in the bag. The opening end of the bag was folded twice and sealed at one central position with scotch tape. The bag was then placed in an electronic oven of an output power of 800W to be heated for 5 minutes, and whether the bag was broken or not was visually observed. The evaluation criteria were as follows. “◯” was graded as a “pass.”

◯: Bag was not broken and scotch tape was not peeled off.

×: Bag was broken or scotch tape was peeled off.

### <Resistance to Air Permeability>

The resistance to air permeability of each of the oil-resistant sheet materials was measured on the basis of JIS P-8117; the resistance to air permeability of seconds or less was marked with “◯,” and the resistance to air permeability exceeding 10000 seconds was marked with “×.” “◯” was graded as a “pass.”

TABLE 1

| | Basis weight | Thickness | Density | Oil | Moisture | Hot water | Bag | Resistance to |
|---|---|---|---|---|---|---|---|---|
| | (g/m²) | (mm) | (g/cm³) | resistance | permeability | resistance | breakage | air permeability |
| Ex. 1 | 45.0 | 0.068 | 0.66 | Δ | ⊚ | X | ◯ | ◯ |
| Ex. 2 | 45.2 | 0.069 | 0.66 | Δ | ⊚ | X | ◯ | ◯ |
| Ex. 3 | 45.4 | 0.069 | 0.66 | ◯ | ◯ | X | ◯ | ◯ |
| Ex. 4 | 45.2 | 0.068 | 0.66 | Δ | ⊚ | X | ◯ | ◯ |
| Ex. 5 | 45.2 | 0.068 | 0.66 | Δ | ⊚ | X | ◯ | ◯ |
| Ex. 6 | 44.8 | 0.067 | 0.67 | ◯ | ◯ | ◯ | ◯ | ◯ |
| Ex. 7 | 44.9 | 0.068 | 0.66 | ⊚ | ◯ | ◯ | ◯ | ◯ |
| Ex. 8 | 45.1 | 0.068 | 0.66 | ◯ | ◯ | ◯ | ◯ | ◯ |
| Ex. 9 | 45.3 | 0.069 | 0.66 | ◯ | ◯ | ◯ | ◯ | ◯ |
| Ex. 10 | 44.1 | 0.065 | 0.68 | ◯ | ⊚ | ◯ | ◯ | ◯ |
| Ex. 11 | 44.9 | 0.068 | 0.66 | Δ | ⊚ | X | ◯ | ◯ |
| Com. Ex. 1 | 45.0 | 0.068 | 0.66 | X | Δ | X | ◯ | ◯ |
| Com. Ex. 2 | 45.1 | 0.068 | 0.66 | X | Δ | ◯ | ◯ | ◯ |
| Com. Ex. 3 | 67.3 | 0.101 | 0.67 | ⊚ | X | X | X | X |
| Com. Ex. 4 | 43.3 | 0.065 | 0.67 | X | ⊚ | ◯ | ◯ | ◯ |
| Com. Ex. 5 | 45.3 | 0.067 | 0.68 | Δ | X | ◯ | X | X |
| Com. Ex. 6 | 45.1 | 0.068 | 0.66 | X | Δ | X | ◯ | ◯ |
| Com. Ex. 7 | 45.3 | 0.069 | 0.66 | X | ⊚ | ◯ | ◯ | ◯ |

### INDUSTRIAL APPLICABILITY

The oil-resistant sheet material according to the present invention is low in resistance to air permeability and has excellent oil resistance and grease resistance, and consequently can be suitably used as a packaging material for food containing edible oil such as breaded fried food, deep-fried food and the like.

1. An oil-resistant sheet material characterized in that at least one coating layer containing starch and alkyl ketene dimer and/or alkenylsuccinic anhydride is formed on at least one side of a substrate in a solid content of 1.5 to 20 g/m².

2. The oil-resistant sheet material according to claim 1, wherein the coating layer further contains a crosslinking agent.

3. The oil-resistant sheet material according to claim 2, wherein the crosslinking agent is an epichlorohydrin crosslinking agent.

4. The oil-resistant sheet material according to claim 1, wherein the starch is a hydrophobized starch.

5. The oil-resistant sheet material according to claim 1, wherein the resistance to air permeability specified in JIS P-8117 is 10000 seconds or less.
